(19) United States
(12) Patent Application Publication
(10) Pub. No.: US 2008/0131566 A1
(43) Pub. Date: Jun. 5, 2008

(54) Feedstuffs additives containing L-lysine with improved abrasion resistance, and process for their prodiction

(75) Inventors: Frank Dubner, Friedberg (DE); Christoph Weckbecker, Grundau-Lieblos (DE); Hermann Lotter, Altenstadt (DE); Joachim Pohlisch, Gelnhausen (DE); Friederike Kappke, Grundau (DE); Ralf Kelle, Gutersloh (DE); Paul Caldwell, Omaha, NE (US); Lee F. Kalivoda, Omaha, NE (US)

Correspondence Address: LAW OFFICE OF MICHAEL A. SANZO, LLC, 15400 CALHOUN DR., SUITE 125, ROCKVILLE, MD, 20855, US

(73) Assignee: Degussa AG, Dusseldorf (DE)

(21) Appl. No.: 11/979,002

(22) Filed: Oct. 30, 2007

Related U.S. Application Data
(63) Continuation of application No. 10/319,843, filed on Dec. 16, 2002, now abandoned.

(51) Int. Cl. A23P 1/08

(52) U.S. Cl. 426/302

(57) ABSTRACT

The invention relates to a shaped, in particular granulated, feedstuffs additive containing L-lysine and treated with additives, preferably oils. The feedstuffs additive has improved abrasion resistance and optionally contains constituents from the fermentation broth and biomass. The invention is also directed to a process for the production of this product.

### FIELD OF THE INVENTION

The invention relates to a shaped, in particular granulated, feedstuffs additive containing L-lysine and treated with additives, preferably oils. The feedstuffs additive has an improved abrasion resistance and optionally contains constituents from the fermentation broth and biomass. The invention is also directed to a process for the production of this product.

### BACKGROUND OF THE INVENTION

An animal feedstuffs additive based on fermentation broth is known from EP 0 809 940 B1 (U.S. Pat. No. 5,840,358), and may be obtained in granulated form in a fluidised bed. This product represented a significant advance over other products known at that time. However, certain problems still remain with regard to the dust formed by abrasion during further processing.

In order to ensure that feedstuffs additives containing carrier materials are free of dust, a mineral oil-containing aerosol in an amount of 0.25 to 2 wt. % may be sprayed onto dust-containing material, 75% of which has a particle size of <400μ (GB 2 293 304 A). An agglomeration of the powder is thereby achieved, in which at least 75% of the particles present have a size of 400 to 1000μ. Inorganic carrier materials are an essential constituent of these mixtures and may comprise up to 96% of the total. The above specification does not give any details of the dust formed after transportation and storage. In addition, the active substances that are used in the specification are pure substances that do not contain any constituents from a fermentation broth.

### OBJECT OF THE INVENTION

There is a need for granulated products containing L-lysine such as occur when using fermentation broths, that have improved handling characteristics. In particular an improvement is needed in abrasion resistance, which is manifested in reduced dust formation after transportation, storage in silos, and processing in the feedstuffs-producing operation, for example using conveyor belts.

### DESCRIPTION OF THE INVENTION

The invention provides substantially dust-free shaped animal feedstuffs additives with improved abrasion resistance. The feedstuffs additives are based on fermentation broth containing L-lysine. Preferably, they also contain the major proportion of the other constituents of the fermentation broth, including the biomass produced during the fermentation in an amount of ≧0 to 100%. The feedstuffs additives are characterised in that:
they contain L-lysine in a concentration of 30 to 90 wt. %, and preferably 40 to 70% relative to the total weight,
preferably ≧97 wt. % of the animal feedstuffs additive, and more preferably ≧98% of the feedstuffs additive has a mean particle size between >0.1 and 1.8 mm, and
they contain on the surface an additional additive in an amount of 0.02 to 2.0 wt. %, preferably 0.02 to 1.0 wt. %, more preferably 0.2 to 1.0 wt. %, and still more preferably 0.2 to 0.6 wt. % relative to the total amount of the feedstuffs additive.

The expression “based on fermentation broth” means that the starting material is a broth containing L-lysine, produced by fermentation (see e.g., EP 0 533 039 B1). This broth also generally contains, as a further essential constituent, the biomass formed during the fermentation, consisting of the amino acid-forming microorganisms. The broth can be separated before the shaping stage, but is generally contained in an amount of up to 100% in the shaped or granulated product.

The expression “on the surface” implies that the added liquid diffuses, even if only slightly, into regions beneath the surface.

“Substantially dust-free” means that the proportion of particles with a size of less than 100 μm is in the range of >0 up to 1%, (preferably up to 0.5 wt. %) and that the dust value is from 0.1 to 5.6, and preferably 0.3 to 2.5.

More than 97 wt. % of the product, preferably more than 98% and still more preferably more than 99% of the feedstuffs additive has a mean particle size of between 0.1 and 1.8 mm. Further preferred constituents of the animal feedstuffs additive (relative to the total amount) include, in addition to the optional biomass derived from the fermentation broth:
L-lysine in an amount of 30 to 90 wt. %, and preferably 40 to 70 wt. %. If the L-lysine content produced in the fermentation is not sufficient, the desired value is adjusted by adding, for example, L-lysine HCl.
Protein present at 0.5 to 20%, preferably at 0.5 to 10%, and more preferably at 0.5 to 7%.
A content of carboxylic acid that is the same as originally contained in the product and constituting at most 13%. Carboxylic acids with fewer than 8 carbon atoms should make up, at most, 10% of the weight.
Fats and oils from the original product (optionally biomass and dissolved fractions from the fermentation broth), making up at most 6% of the weight.
   The product does not contain inorganic carrier materials such as those described for example in GB 2 293 304 A.

Granules produced according to EP 0 809 940 B1 constitute preferred starting products for the feedstuffs additives that can be produced according to the invention. The granules should have a mean particle size between 0.1 and 1.8 mm (≧97%), and preferably ≧95 wt. % of the particles have a particle size in the range of between 0.3 and 1.8 mm. In a particularly preferred variant, the particle size is in the range of between 0.3 and 1.5 mm (≧95%). These granules are preferably obtained by spraying fermentation broths containing L-lysine in fluidised bed granulation drying units. However, granules or shaped animal feedstuffs additives produced in another way and that contain lysine may also be used (e.g., EP 0 615 693 B1).

The dust fraction (particles <100μ) of the starting material is ideally <3 wt. %. This value should not however be regarded as critical. Amounts of, for example, up to 10 wt. % may also be used without very fine dust having to be separated beforehand. Since very fine dust amounts of <3% are very difficult to determine gravimetrically, an optical test was developed.

The optical analysis of dust content was carried out as follows. 50 g of the product was allowed to fall 0.8 metre in a closed chamber having the dimensions 320 (W)×210 (D)×950 (H) mm. When the product falls to the floor, the dust whirls up into the air space. The attenuation of a light beam in the head space of the apparatus is measured as a function of time, and the maximum value (%) is recorded. A halogen lamp (not a monochromatic light source) serves as the light source. This measurement may be repeated after 30 seconds to obtain the 30-second value. At values of less than 5 the product appears to be virtually optically dust free. If the dust value is above 20, the very fine dust fraction in the product can also be determined in a simple manner gravimetrically according to the prior art.

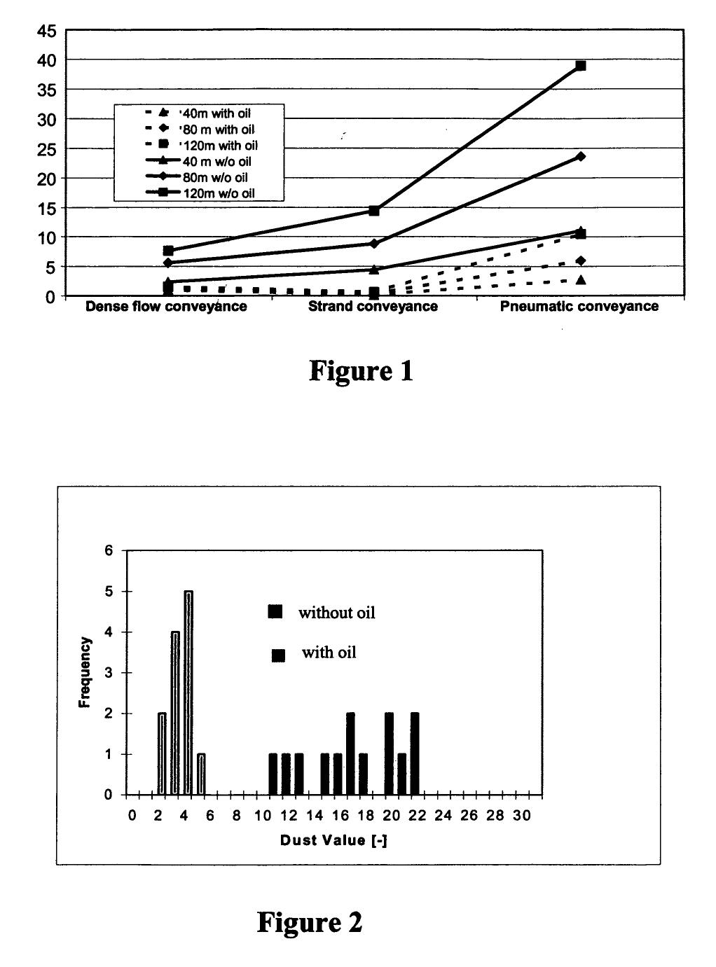

The dust content of the untreated product drastically increases under mechanical stress, such as occurs for example when the product is conveyed. In the case of pneumatic transportation over 40 to 120 m, the untreated product may have a 100% greater dust fraction and a dust value that is three times as large compared to the treated product (see Table 1). These figures also apply to other types of mechanical conveyance (see FIG. 1). These values were measured after combining the product with the finely particulate fractions that are conventionally trapped in filters. The additionally recorded dust fraction consists especially of 10 to ca. 90 μm, in particular 10 to ca. 50 μm large, granule fragments that have flaked off, and which have a composition that is identical to the desired product. The product according to the invention is, preferably, substantially round and compact in appearance.

The very fine dust fraction (<100μ) after conveyance over 40, 80 or 120 m by various methods (dense flow, strand, pneumatic) is <1 wt. %, and preferably <0.5 wt. %, if products according to the invention are used having a dust value of ≦ca. 1. Dust values of ≦ca. 11, and preferably ≦ca. 6, are found in particular with conveying lengths of 40 or 80 m. In dense flow conveyance, air speeds of 1.5 to 4 m/sec and product/air ratios of 30 to 80 are generally employed. In strand conveyance, the ranges are 5 to 15 m/sec and a product/air ratio of 6 to 20. The values for pneumatic conveyance are 17 to 30 m/sec and a product/air ratio of 1 to 5.5.

The constituents of a feedstuffs additive based on fermentation broth are known per se to the person skilled in the art. These constituents optionally comprise the total amount, or part, of the biomass formed during the fermentation. Alternatively, the fermentation broth contains, apart from L-lysine, dissolved constituents that are derived from the nutrient medium, or compounds separated from the micro-organism employed.

The bulk density of the shaped, preferably granulated, feedstuffs additive is generally in the range of 600 to 900 kg/m³, and preferably 650 to 850 kg/m³.

After the addition according to the invention of the aforementioned additives in an amount of 0.1 to 2.0%, an increase in [the] bulk density was observed (see Table 5). Mineral oils, vegetable oils or mixtures of vegetable oils may be used as oils (additives). These include, in particular, oils that are liquid at room temperature, such as soybean oil, olive oil, soybean oil/lecithin mixtures or other edible oils, as long as they do not alter the character of the animal feedstuffs additives. Silicone oils, polyethylene glycols or hydroxyethylcellulose in aqueous solution are also suitable as additives. Oil-water emulsions may also be used. Furthermore, complex by-products obtained from the sugar and starch industry, such as corn steep liquor, may be used as additives. These may include oily by-products, for example, in the form of phospholipid fractions, formed in the extraction and hydrolysis of maize starch.

The liquid treatment agent is applied to the particles at a temperature of 10 to 100° C., preferably 20 to 60° C. Although the feedstuffs additive to be treated has, due to its derivation from fermentation, an analysable oil fraction, only surface treatment with the aforementioned additives, in particular oils, leads to the improved abrasion resistance of the product.

It is possible to distinguish clearly the treated product from the starting products optically under the microscope by the shape of the surface, as well as by the significantly smaller dust fractions. At the same time, the undesirable clumping of the particles due to the additional oil content does not occur on prolonged storage, and, as a result, flow behaviour is not impaired.

The product according to the invention has, after mechanical stress, a significantly narrower grain size distribution than untreated granulated animal feedstuffs additive. Under mechanical stress the initial granules are destroyed, to some extent with dust formation, and the grain spectrum is broadened. This is manifested, for example, during storage in silos in the form of an undesirable demixing of the stored product. As a result, dust fractions and dust values will vary considerably depending on the sampling site. Corresponding incalculable dust loads occur on emptying silos, when such demixed products are being loaded. This problem does not occur with the product according to the invention.

The invention also provides a process for the production of a feedstuffs additive containing lysine based on fermentation broth and having an improved abrasion resistance. The starting product contains the major proportion of the constituents of the fermentation broth, including ≧0 to 100% of the biomass produced. The process is characterised in that a shaped, in particular granulated, animal feedstuffs additive containing 30 to 90 wt. %, and preferably 40 to 70 wt. %, of L-lysine, with a mean particle size preferably in the range from >0.1 to ≦1.8 mm, is sprayed with an additive. The aforementioned sprayed additive, preferably an oil, is provided in an amount of 0.02 to 2 wt. % relative to the animal feedstuffs additive that is used. Preferably 0.2 to 1 wt. %, and more preferably 0.1 to 0.6 wt. %, of sprayed additive is provided. An improved abrasion resistance is achieved by the addition of these small amounts of spray additive and, in addition, the very fine dust fraction that is present becomes bound. The largely dust-free product that is thereby formed and the optimised free-flowing behaviour lead to an improved handling of the product. This stability is found to be unchanged in long-term storage tests and under storage at high temperatures.

The additive may be added batchwise or continuously. In order to achieve a uniform distribution of the additive in the product, it is recommended that it be fed through one or more nozzles. Mechanical or pneumatic mixers may be used as mixing equipment and may include:
vessels rotating about one or more axes, such as rotary tube mixers, tumble dryers, double-cone dryers,
vessels with fixed or moving mixing tools such as turbulent flow mixers, ploughshare mixers, paddle-screw mixers,
airmix mixers.

The additive may also be sprayed in during other process stages and mixed with the animal feedstuffs additive, such as for example:
in the bed of a fluidised bed dryer,
in a pneumatically operating product conveyor line,
in a screw-driven product conveyor line,
in a product silo with mechanical or pneumatic mixing.

The product obtained has, despite the liquids added in minor amounts and the hydrophilic nature of the feedstuffs additive, a homogeneous distribution of these liquids. No agglomerates or lumps are formed.

### EXAMPLES

### Example 1

### Production

100 kg of an L-lysine-containing feedstuffs additive (granules) produced according to EP 0 809 940 B1 were added to a 300 l capacity Lodige ploughshare mixer (60% filling) and the mixer was set to a speed of 150 rpm. 0.5 kg of soybean oil was then added through a hollow-cone nozzle having a 1.1 mm bore. The dust content was analysed after a mixing time of 60 seconds. The dust value before oil addition was 9.0. After oil addition, the dust value was 0.1. It can be seen that the very fine dust fraction is bound to the granule particles.

The granular starting material included the biomass and constituents from the fermentation. It contained at least 46.8% lysine and had a bulk density of 600 to 800 kg/m³. This product was also used in the further examples as described below.

The bulk density was measured according to DIN 1060, except that the feedstuffs additive continuously falls through the funnel into the bulk material vessel. It is not collected in the funnel, which is then emptied into the bulk material vessel after opening a cap.

### Example 2

### Influence of the Oil Treatment on the Dust Content Under Pneumatic Conveyance

TABLE 1

| | | Conveying | Dust Amount in the Filter | Ratio of Dust in the Filter to Total | |
|---|---|---|---|---|---|
| | Time | Length | after in each case 40 m | Amount of Product | Dust Value |
| Product | Min | m | g | % | — |
| without oil | | 0 | | | 1 |
| | 3.16 | 40 | 148 | 0.4 | 11 |
| | 3.08 | 80 | 122 | 0.72 | 23.6 |
| | 2.87 | 120 | 236 | 1.36 | 38.9 |
| | | | 506 | 1.36 | |
| with 0.5% oil | | 0 | | | 0.2 |
| | 3.66 | 40 | 50 | 0.11 | 2.75 |
| | 3.66 | 80 | 90 | 0.32 | 6 |
| | 3.66 | 120 | 90 | 0.52 | 10.5 |
| | | | 230 | 0.52 | |

The measurements show a significantly reduced dust formation on account of the improved abrasion resistance after the treatment of the animal feedstuffs granules with oil (soybean oil). Both products were previously practically dust-free in order to avoid falsification of the results by any dust contents already present.

### Example 3

### Influence of Various Oils on the Dust Content

TABLE 2

| Test | Dust Value |
|---|---|
| Without oil | 5.6 |
| +0.5% mineral oil, low viscosity | 2.5 |
| +0.52% mineral oil, viscous | 1.4 |
| +0.55% silicone oil, industrial | 1.6 |
| +0.52% olive oil, native | 1.5 |

### Example 4

### Use of Various Oils

The starting product according to Example 1 was used in an amount of 400 g, and was stirred with a blade mixer (60 rpm) and sprayed with the various oils.

TABLE 4

| | | Amount | Temp. | Time | Dust Value |
|---|---|---|---|---|---|
| Experiment | Additive | (%) | (° C.) | (min.) | (—) |
| 1^{st} pattern | without | | | | 20.9 |
| A | AU10 | 1.38 | 50 | 10 | 0.2 |
| B | AU10 | 1 | 60 | 5 | 0.1 |
| C | AU20 | 0.55 | 60 | 5 | 1.3 |
| D | AU30 | 0.563 | 40 | 5 | 0.7 |
| E | edible oil | 0.5 | 60 | 5 | 3.7 |
| F | PEG400 | 0.75 | 60 | 5 | 0.6 |
| G | CSL | 0.875 | 60 | 5 | 5.3 |
| 2^{nd} pattern | without | | | | 17.7 |
| A | soybean oil | 0.825 | 60 | 5 | 0.7 |
| B | soybean oil | 1.28 | 60 | 5 | 0.1 |
| C | crude soybean | 0.33 | 60 | 5 | 0.8 |
| | oil | | | | |

It can be seen that there is a significant reduction in the dust content when using various oils and additives.

Abbreviations used:
PEG400: polyethylene glycol
CSL: corn steep liquor
AU: lecithin/soybean oil mixtures (AU: acetone-insouluble fraction)

TABLE 5

| | |
|---|---|
| 1) AU 10 | 16.1 g lecithin(AU 62) |
| | 83.9 g |
| | soybean oil |
| 2) AU 20 | 32.3 g lecithin(AU 62) |
| | 67.7 g |
| | soybean oil |
| 3) AU 30 | 48.4 g lecithin(AU 62) |
| | 51.6 g |
| | soybean oil |

### Example 5

### Properties of the Treated Product

Oil was sprayed (60° C.) onto the animal feedstuffs additive (see Example 1) in a 150 l capacity ribbon mixer (28 rpm, t=4 min).

TABLE 6

| | | | | | |
|---|---|---|---|---|---|
| Oil addition | — | +0.1 | +0.2 | +0.3 | +0.5 |
| % | | | | | |
| Flowability | 2 | 2 | 2 | 2 | 2 |
| Bulk density | 760 kg/m³ | 770 kg/m³ | 770 kg/m³ | 790 kg/m³ | 810 kg/m³ |
| Dust value | 6 | 2 | 0.6 | 0.3 | 0.1 |
| Water uptake | +5% | +4% | +4% | +4% | +4% |
| 1 hr/40° C./ | | | | | |
| 75% | | | | | |
| Water uptake | +13% | +12% | +14% | +12% | +12% |
| 4 hrs/40° C./ | | | | | |
| 75% | | | | | |

### Example 6

### Influence of the Addition of Oil in Various Forms of Transportation, on the Abrasion

An animal feedstuffs additive as described in Example 1 was conveyed under various conditions matching practical applications. The conveyance involved dense flow, strand and pneumatic conveyance with conveying lengths of 40 to 120 m. These are operated at different air speeds and product/air ratios. The following were selected in the present case:

TABLE 7

| | Air Speed | Product/Air Ratio |
|---|---|---|
| | (m/sec) | (μ) |
| Dense flow | 2.2 | 55 |
| conveyance | | |
| Strand conveyance | 7.3 | 10.6 |
| Pneumatic | 24.0 | 3.3 |
| conveyance | | |

The value for the dust includes the dust deposited in the filter. The influence of the treatment of the granulated starting product, in this case with soybean oil, on the abrasion can clearly be seen, which is measured as the dust value after mechanical treatment over various conveying lengths compared to the starting product (FIG. 1).

### Example 7

### Demixing Behaviour in the Silo

Untreated granulated animal feedstuffs additive and additive treated with 0.5 wt. % soybean oil were in each case discharged from a silo into 1000 kg sacks. A sample was taken from every tenth sack and the dust content was measured; the maximum value as well as the value after 30 seconds' settling time were measured. A bandwidth of the dust value ranging from 10.1 to 21.7 is found in the untreated product (Table 7). The dust value for the treated animal feedstuffs additive is between 1.7 and 4.1, with a mean value of 2.9 (Table 8). The mean value of 1.6 for the dust content after 30 seconds points to the extremely low very fine dust content in the treated product.

FIG. 2 shows the distribution of the dust values of Example 7. The number of sacks having the corresponding dust value is given under “Frequency.” The untreated product does not exhibit a standard distribution but instead a broad scatter of the dust value. This means that batches with significantly varying, increased dust fractions occur within any one lot. This accords with the empirical result that the dust fraction of product fractions contained in a silo cannot be predicted.

On account of its improved abrasion behaviour the treated product has only a very low dust fraction and thus a narrow particle spectrum. The particle distribution in a silo expressed as the dust value has the form of a standard distribution, with a very small standard deviation. This is confirmation of the fact that, after treatment of the product, unpredictable “dusty fractions” no longer have to be expected when emptying a silo.

TABLE 8
Untreated Product

| Sample | Dust Value | Dust Value after 30 sec |
|---|---|---|
| 1 | 21.2 | 14.6 |
| 2 | 11.5 | 9.8 |
| 3 | 10.1 | 7.7 |
| 4 | 16.5 | 14.3 |
| 5 | 13.0 | 10.6 |
| 6 | 17.1 | 10.8 |
| 7 | 21.7 | 17.5 |
| 8 | 16.3 | 14.1 |
| 9 | 19.1 | 13.3 |
| 10 | 14.5 | 11.4 |
| 11 | 20.0 | 14.2 |
| 12 | 20.8 | 13.9 |
| 13 | 15.4 | 10.1 |
| Min. | 10.1 | 7.7 |
| Max. | 21.7 | 17.5 |
| Average | 16.7 | 12.5 |
| Standard deviation | 3.76 | 2.65 |

TABLE 9
Product treated with soybean oil

| Sample | Dust Value | Dust Value after 30 sec |
|---|---|---|
| 1 | 2.3 | 1.4 |
| 2 | 1.8 | 0.9 |
| 3 | 1.7 | 1.1 |
| 4 | 3.5 | 1.4 |
| 5 | 4.1 | 1.7 |
| 6 | 3.7 | 2.3 |
| 7 | 3.3 | 1.7 |
| 8 | 2.9 | 1.5 |
| 9 | 2.7 | 1.7 |
| 10 | 3.1 | 1.9 |
| 11 | 3.4 | 1.7 |
| 12 | 2.6 | 1.7 |
| Min. | 1.7 | 0.9 |
| Max. | 4.1 | 2.3 |
| Average | 2.9 | 1.6 |
| Standard deviation | 0.74 | 0.36 |

1-13. (canceled)

14. A process for improving the demixing behavior of a shaped feed additive product that has been stored in a silo, said process comprising: prior to storage in said silo, spraying said shaped feed additive product with a spray compound in an amount such that the final feed additive product comprises on its surface 0.02-2 wt % of said spray compound and wherein said spray compound is selected from the group consisting of: an edible oil, a silicone oil; or a polyethylene glycol.

15. The process of claim 14, wherein fats and oils represent 6% or less of the total weight of said feed additive product.

16. The process of claim 15, wherein 30-90 wt % of said feed additive product is L-lysine.

17. The process of claim 16, wherein said feed additive product has a mean particle size of 0.1-1.8 mm.

18. The process of claim 17, wherein 0.1-10 wt % of said feed additive has a particle size of less than 100μ.

19. The process of claim 18, wherein said spray compound is selected from the group consisting of: a mineral oil; a vegetable oil; soybean oil; olive oil; and a soya/lecithin mixture.

20. The process of claim 18, wherein said spray compound is selected from the group consisting of: a silicone oil; and a polyethylene glycol.

21. The process of claim 14, wherein carboxylic acids constitute no more than 13% of said feed additive product and carboxylic acids with fewer than 8 carbon atoms make up, at most, 10% of the weight.

22. The process of claim 14 wherein said feed additive is sprayed in fluidised bed granulation drying unit.

23. The process of claim 14, wherein said feed additive is sprayed in a moving conveyer line.

24. The process of claim 14, wherein said feed additive is sprayed in a mechanical or pneumatic mixer.

25. A process for improving the demixing behavior of a shaped feed additive product in a silo, said process comprising: prior to storage in said silo, spraying said shaped feed additive product with a spray compound in an amount such that the final feed additive product comprises on its surface 0.02-2 wt % of said spray compound and wherein said spray compound is selected from the group consisting of: an edible oil, a silicone oil; or a polyethylene glycol and wherein:
a) fats and oils represent 6% or less of the total weight of said feed additive product;
b) carboxylic acids constitute no more than 13% of said feed additive product and carboxylic acids with fewer than 8 carbon atoms make up, at most, 10% of the weight.

26. The process of claim 25, wherein 30-90 wt % of said feed additive product is L-lysine.

27. The process of claim 25, wherein said feed additive product has a mean particle size of 0.1-1.8 mm.

28. The process of claim 27, wherein 0.1-10 wt % of said feed additive has a particle size of less than 100μ.

29. The process of claim 25, wherein said spray compound is selected from the group consisting of: a mineral oil; a vegetable oil; soybean oil; olive oil; and a soya/lecithin mixture.

30. The process of claim 25, wherein said spray compound is selected from the group consisting of: a silicone oil; and a polyethylene glycol.

31. The process of claim 25, wherein said feed additive is sprayed in fluidised bed granulation drying unit.

32. The process of claim 25, wherein said feed additive is sprayed in a moving conveyer line.

33. The process of claim 25, wherein said feed additive is sprayed in a mechanical or pneumatic mixer.
